(19) United States
(12) Patent Application Publication
(10) Pub. No.: US 2008/0062490 A1
(43) Pub. Date: Mar. 13, 2008

(54) Holographic Storage System

(75) Inventors: Hsin-Ping Cheng, Hsinchu (TW); Chia-Yen Chang, Hsinchu (TW)

Correspondence Address: WPAT, PC, 7225 BEVERLY ST., ANNANDALE, VA, 22003, US

(73) Assignee: LITE-ONIT CORP., Taipei City (TW)

(21) Appl. No.: 11/619,615

(22) Filed: Jan. 4, 2007

(30) Foreign Application Priority Data
Sep. 7, 2006 (TW) 095132978

(51) Int. Cl. G03H 1/22

(52) U.S. Cl. 359/32; 359/15

(57) ABSTRACT

A holographic storage system. A low over-sampling technology and an adaptable gain-controlling unit are used in the holographic storage system for unequally amplifying signals generated by a detecting apparatus. Then the amplified signals generated by the detecting apparatus are summed in order to generate summing signals, which are used to detect original image frames for raising the resolution of the images and reducing the error rate of the data.

### FIELD OF THE INVENTION

The present invention relates to a holographic storage system, and more particularly to a detecting apparatus and a detecting method within the holographic storage system.

### BACKGROUND OF THE INVENTION

FIG. 1 depicts a holographic storage system diagram, wherein the holographic storage system 100 includes a signal beam 12, a data plane 14, a reference beam 16, a storage medium 18, a data beam 22, and a detecting apparatus 20.

A light source, e.g. a laser light source, is split into two light beams by a beam splitter (not shown), wherein one of the two light beams is converted to the signal beam 12 after the light beam is emitted to the data plane 14, which means an image frame presented on the data plane 14 is also contained in the signal beam 12; and another light beam is the reference beam 16. When the signal beam 12 and the reference beam 16 are both focused on the storage medium 18, an interference strip, generated by the signal beam 12 and the reference beam 16, is formed on the focal point 24, wherein the interference strip can be regarded as a grating. When only the reference beam 16 emits the storage medium 18, the data beam 22 is generated and outputted from the extended direction of the signal beam 12, and the image frame originally presented on the data plane 14 can be read out if the detecting apparatus 20 is placed on the path of the data beam 22.

A data-recording process in the holographic storage system 100 includes steps of: converting the original data to an image frame and presenting the image frame on the data plane 14; converting a light beam to the signal beam 12 via emitting the light beam to the data plane 14; and recording the focal point 24 with an interference strip in the storage medium via focusing the signal beam 12 and the reference beam 16 on the focal point 24. A data-reading process in the holographic storage system 100 includes steps of: focusing the reference beam 16 on the focal point 24 in the storage medium 18 to generate the data beam 22 outputted from the extended direction of the signal beam 12; placing the detecting apparatus 20 on the path of the data beam 22 for presenting the image frame contained in the data beam 22 on the detecting apparatus 20; and converting the image frame presented on the detecting apparatus 20 to the original data.

Generally, the data plane 14 is a SLM (spatial light modulator), wherein the SLM can be a DMD (digital micro-mirror device) or a LCD (liquid crystal display). Both the DMD and the LCD are composed by a plurality of presenting units arranged as an array, and these presenting units with different intensities can present an image frame. In addition, the storage medium 18 is a Photopolymer. The detecting apparatus 20 can be a CCD (charge-coupled device) or a CMOS (complementary metal oxide semiconductor). Both the CCD and the CMOS are also composed by a plurality of sensing units arranged as an array, wherein these sensing units are use for receiving the image frame presented on the resenting units of the data plane 14.

A deformation of the storage medium 18 may be happened during the process of data recording, and the deformation may be also happened when the temperature where the storage medium 18 within is varying. The deformation may further result in the vector or the size of the grating recorded in the storage medium change. Therefore, during the process of reading the data recorded in the storage medium 18, an included angle mat be happened between the data beam 22 and the extended direction of the signal beam 12. If the detecting apparatus 20 is still placed on the path of the extended direction of the signal beam 12, a misalignment between the image frame presented on the detecting apparatus 20 and the sensing units will be happened, wherein the misalignment can be regarded as an image-frame shift. A serious image-frame shift may further result in the image frame cannot be restored back to the original data.

FIG. 2(a) depicts a diagram of an original image frame presented on a data plane 14. Assuming the resolution of the data plane 14 is 2×2, and the data plane 14 includes the presenting units 14a and 14d with a light state and presenting units 14b, 14c with a dark state. Moreover, as the depicted in the FIG. 2(b), assuming the resolution of the detecting apparatus 20 is also 2×2, and the detecting apparatus includes the sensing units 20a and 20b, 20c, and 20d.

If there is no image-frame shift between the image frame presented on the detecting apparatus 20 and the sensing units 20a˜20d, each single sensing unit can receive an image generated by each corresponding single presenting unit, which means the images generated by the presenting units 14a, 14b, 14c, and 14d are received by the sensing units 20a, 20b, 20c, and 20d, respectively. Each sensing unit, 20a, 20b, 20c, and 20d can output a sensing signal corresponding to the intensity received by each sensing unit. Therefore, the sensing units 20a, 20d will output a sensing signal representing a light state, and the sensing units 20b, 20c will output a sensing signal representing a dark state. There is a processing circuit for processing these sensing signals to restore back to the original data.

However, if a misalignment is happened between the image frame presented on the detecting apparatus 20 and the sensing units 20a˜20d, each single sensing unit is not able to receive the image generated by each corresponding presenting unit, respectively. As depicted in FIG. 2(c), there is a misalignment between the image frame 30 and the sensing units 20a˜20d, the image with a light state originally presented on the presenting unit 14a is received by the sensing units 20a and 20c; the image with a dark state originally presented on the presenting unit 14b is received by the sensing units 20a, 20b, 20c, and 20d; the image with a dark state originally presented on the presenting unit 14c is received by the sensing unit 20c; and the image with a light state originally presented on the presenting unit 14d is received by the sensing units 20c and 20d, which means the sensing units 20a˜20d within the detecting apparatus 20 may receive images generated from different presenting units at the same time. Because the sensing signal outputted from each sensing unit is determined according to the intensity received by the sensing unit itself, therefore, it is difficult for the processing circuit to process the sensing signals back to the original image frame, which means when the processing circuit process these sensing signals, it is hard to identify these sensing signals are representing light states or dark states. Therefore, reading errors will be happened during the process of image frames converting to the original data.

The conventional problem, a misalignment between the image frame and the sensing unit, can be fixed by an over-sampling technology, wherein the over-sampling technology is use for providing a detecting apparatus having a higher resolution than the data plane. FIG. 3 depicts a diagram of a detecting apparatus adopting 3× over-sampling technology. The detecting apparatus 40 uses nine (3×3) sensing units for processing an image generated by a single presenting unit, which means the detecting apparatus 40 with 6×6 resolution is use for the data plane 14 with 2×2 resolution depicted in FIG. 2(a). As depicted in FIG. 3, nine sensing units detect one single image, and each of these nine sensing units outputs a sensing signal, and these nine sensing signals are summed by a SUM (summing unit). After these nine sensing signals are summed as a summing signal, the SUM outputs the summing signal to the processing circuit for identifying the original image presented on the presenting unit.

It is understood that more sensing units use for detecting an intensity generated by a presenting unit, the corresponding summing signal has a higher identification. However, the over-sampling technology may consume more computation power of the processing circuit, so as to reduce the performance of the holographic storage system. Therefore, reaching higher image identification by a lower over-sampling technology is the main purpose of this present invention.

### SUMMARY OF THE INVENTION

The present invention relates to a holographic storage system, the holographic storage system is use for raising the identifying rate of an image frame by adopting a low over-sampling technology and a gain-controlling unit capable of providing a changeable gain. The present invention relates to a holographic storage system including: a first light beam; a second light beam; a data plane including n presenting units for presenting an image frame, wherein the second light beam is converted to a signal beam containing the image frame after the second light beam is emitted to the data plane, and each presenting unit is capable of outputting a light state or a dark state; a storage medium, wherein the first light beam and the signal beam are both focused on a focal point in the storage medium when the storage medium is use for data recording, and a data beam is generated if only the first light beam is focused on the focal point in the storage medium when the storage medium is use for data reading; a detecting apparatus including m sensing units for receiving the image frames contained in the data beam and each sensing unit is capable of generating a corresponding sensing signal, wherein the m/n is an integer or a rational; m gain-controlling units, connected to the m sensing units, for providing different gains to respectively amplify the corresponding sensing signals outputted from the sensing units; and n SUMs, wherein each SUM is capable of outputting a summing signal which is a sum of partial amplified sensing signals within the m amplified sensing signals.

In an embodiment, the first light beam and the second light beam are from a laser beam split by a beam splitter.

In an embodiment, the spatial light modulator can be a digital micro-mirror device or a liquid crystal display

In an embodiment, the storage medium is a Photopolymer.

In an embodiment, the detecting apparatus is a charge-coupled device or a complementary metal oxide semiconductor.

In an embodiment, the n summing signals are use for identifying the images presented on the n corresponding presenting units.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a diagram of a holographic storage system.

FIG. 2(a) is a diagram of an original image frame presented on a data plane.

FIG. 2(b) is a diagram of a detecting apparatus.

FIG. 2(c) is a diagram of a misalignment happened between an image frame and a detecting apparatus.

FIG. 3 is a diagram of a detecting apparatus adopting a 3× over-sampling technology.

FIG. 4 is a diagram of a holographic storage system of this present invention.

FIG. 5(a) is a diagram of an image frame presented on a data plane of this present invention.

FIG. 5(b) is a diagram of a detecting apparatus of this present invention.

FIG. 5(c) is a diagram of a misalignment happened between an image frame and a detecting apparatus.

FIG. 6 is a diagram of a identifying rate resulted from a 2× over-sampling technology adopted with the present invention.

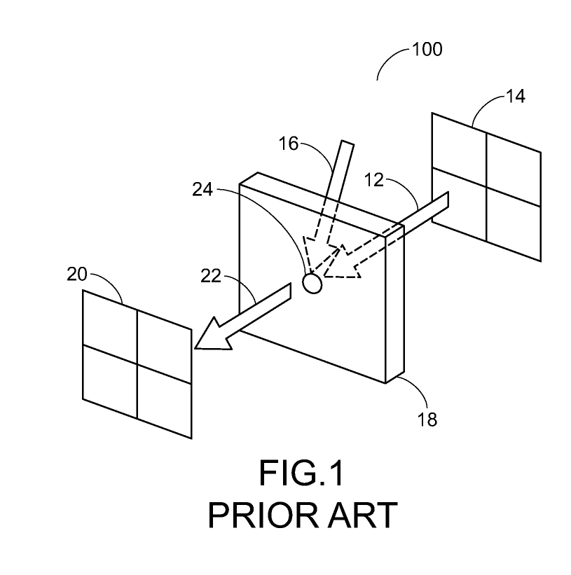

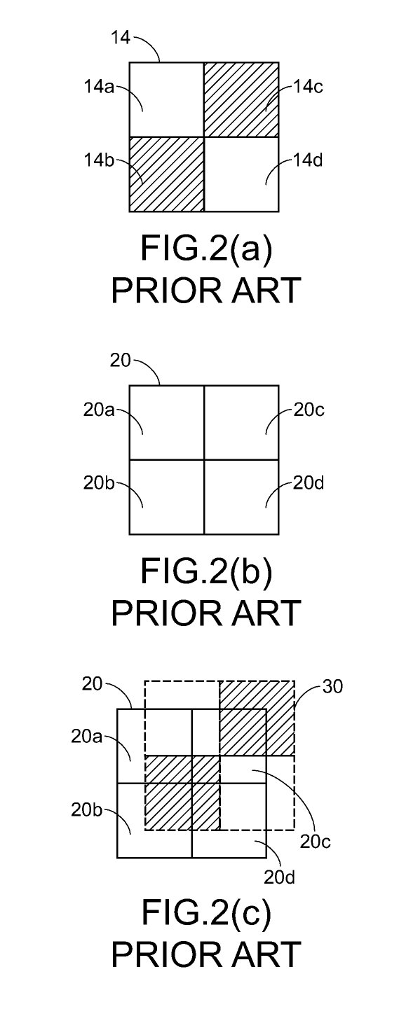

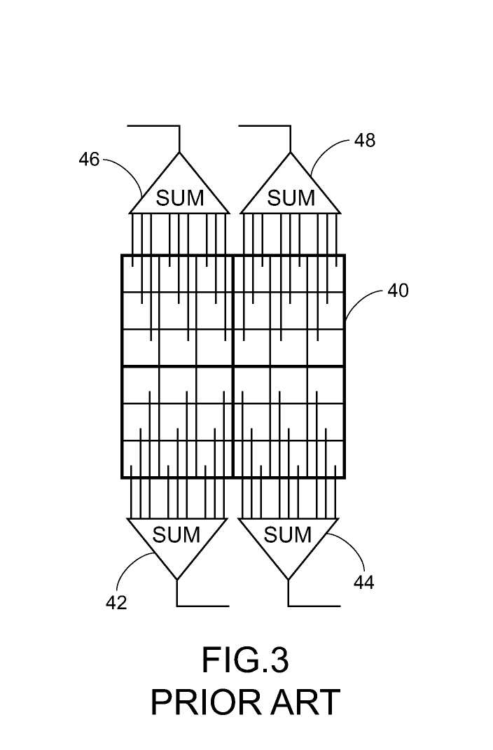

### DETAILED DESCRIPTION OF THE PREFERRED EMBODIMENT

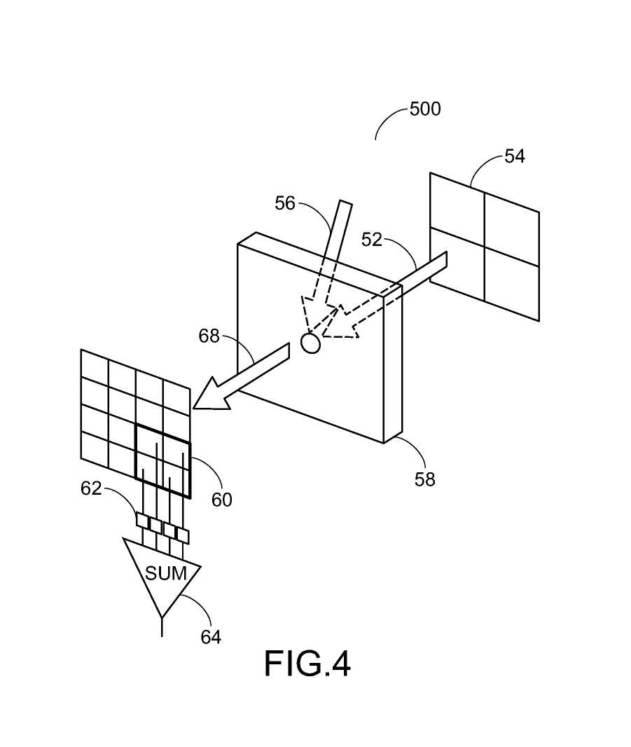

FIG. 4 depicts a holographic storage system of the present invention, wherein the holographic storage system 500 includes a signal beam 52, a data plane 54, a reference beam 56, a storage medium 58, a data beam 68, a detecting apparatus 60, a gain-controlling unit 62, and a SUM 64.

Because a higher over-sampling technology can provide a better resolution, but also consumes more computation power, therefore, a 2× over-sampling technology is adopted in the detecting apparatus 60 of this present invention, so as there are four (2×2) sensing units use for processing an image generated by a single presenting unit. In addition, every sensing signal outputted from each sensing unit is connected to a corresponding gain-controlling unit 62, and each gain-controlling unit 62 can provide a changeable gain to the sensing signal. The SUM 64 sums the four sensing signals, amplified by the corresponding gain-controlling unit 62, as a summing signal, and the summing signal is outputted to a processing circuit for further identifying.

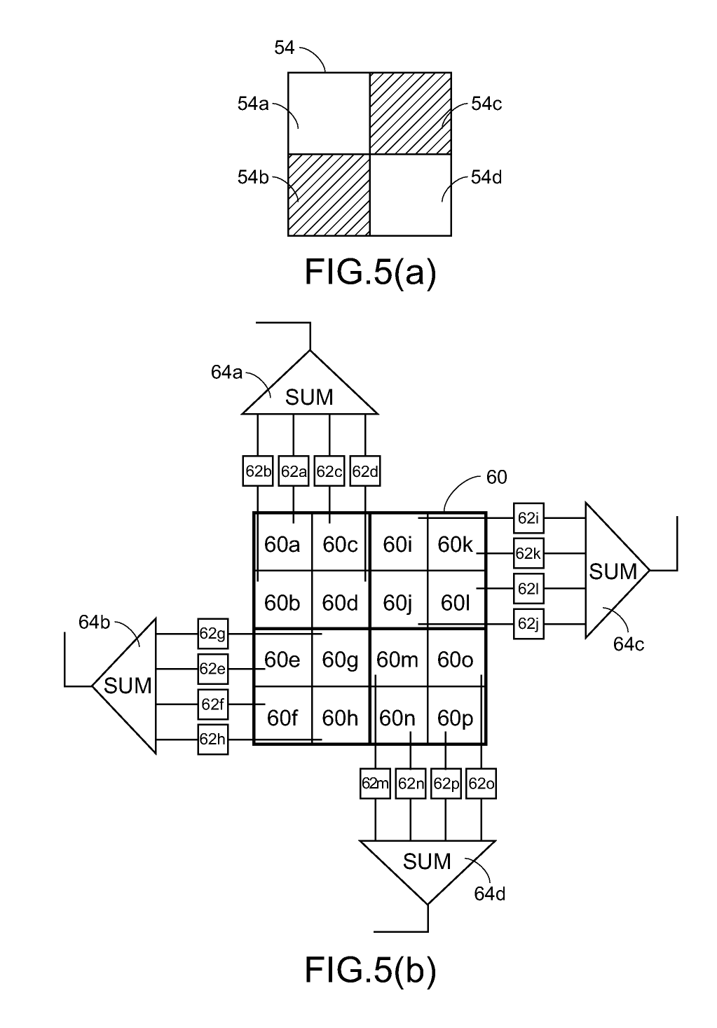

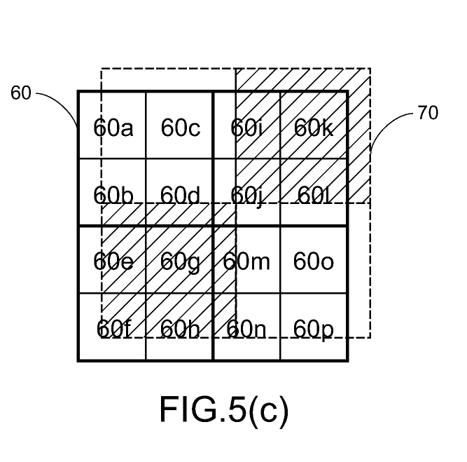

FIG. 5(a) depicts an image frame presented on the data plane 54, wherein the presenting units 54a and 54d present an image with a light state, and the presenting units 54b and 54c present an image with a dark state. FIG. 5(b) depicts a diagram of the detecting apparatus 60 of this present invention. There are 16 sensing units 60a˜60p in the detecting apparatus 60, wherein the sensing signals from the sensing units 60a˜60d are inputted to the four gain-controlling units 62a˜62d and amplified by the four gain-controlling units 62a˜62d, respectively, and the four amplified sensing signals are summed as a summing signal and outputted by the SUM 64a; the sensing signals from the sensing units 60e˜60h are inputted to the four gain-controlling units 62e˜62h and amplified by the four gain-controlling units 62e˜62h, respectively, and the four amplified sensing signals are summed as a summing signal and outputted by the SUM 64b; the sensing signals from the sensing units 60i˜60l are inputted to the four gain-controlling units 62i˜62l and amplified by the four gain-controlling units 62i˜62l, respectively, and the four amplified sensing signals are summed as a summing signal and outputted by the SUM 64c; the sensing signals from the sensing units 60m˜60p are inputted to the four gain-controlling units 62m˜62p and amplified by the four gain-controlling units 62m˜62p, respectively, and the four amplified sensing signals are summed as a summing signal and outputted by the SUM 64d; and each of the gain-controlling units 62a˜62p can provide different gains.

When there is a misalignment between the image frame presented on the detecting apparatus 60 and the sensing units 60a˜60p, the different gains provides by the gain-controlling units 62a˜62p will be respectively applied to the sensing signals outputted from the sensing units 60a˜60p to make the summing signals outputted from the SUM 64a˜64d are easier to be identified. FIG. 5(c) depicts a misalignment happened when the image frame 70 is presented on the detecting apparatus 60. For convenience, the gain-controlling units and the SUM are ignored in the FIG. 5(c). For increasing the identification of the images frame presented on the detecting apparatus 60, the gain-controlling unit 62c is designed to provide a gain higher than the gains provided by the gain-controlling units 62a and 62b, and the gain-controlling unit 62d is designed to provide a lowest gain, therefore, the processing circuit can have a higher identifying ability to the image presented on the presenting unit 54a after the summing signal is outputted from the SUM 64a; the gain-controlling unit 62g is designed to provide a gain higher than the gains provided by the gain-controlling units 62e and 62h, and the gain-controlling unit 62f is designed to provide a lowest gain, therefore, the processing circuit can have a higher identifying ability to the image presented on the presenting unit 54b after the summing signal is outputted from the SUM 64b; the gain-controlling unit 62k is designed to provide a gain higher than the gains provided by the gain-controlling units 62i and 62l, and the gain-controlling unit 62j is designed to provide a lowest gain, therefore, the processing circuit can have a higher identifying ability to the image presented on the presenting unit 54c after the summing signal is outputted from the SUM 64c; the gain-controlling unit 62o is designed to provide a gain higher than the gains provided by the gain-controlling units 62m and 62p, and the gain-controlling unit 62n is designed to provide a lowest gain, therefore, the processing circuit can have a higher identifying ability to the image presented on the presenting unit 54d after the summing signal is outputted from the SUM 64d.

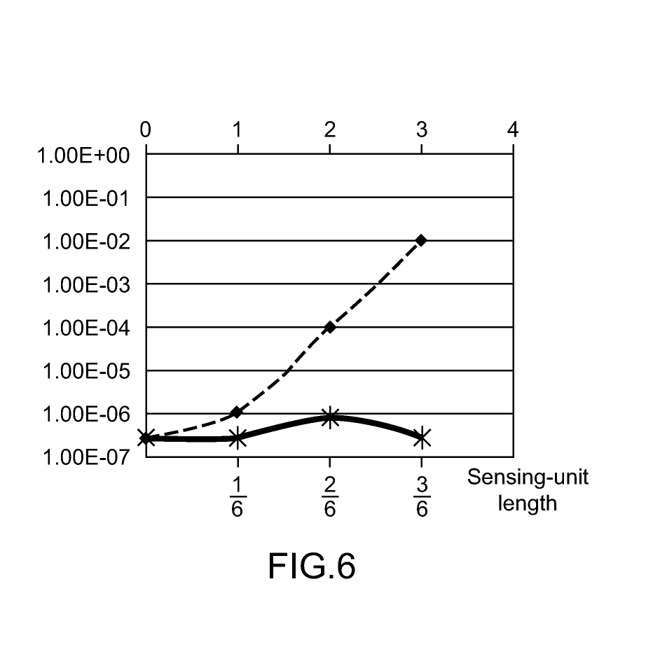

FIG. 6 is a diagram of an identifying rate resulted from a 2× over-sampling technology adopted with the present invention, wherein the x-coordinate represents the image-frame shift, and the unit of the x-coordinate is ⅙ sensing-unit length; and the y-coordinate represents the error-data rate. As depicted in the FIG. 6, the worst image-frame shift is ½ sensing-unit length. If the image-frame shift is over than ½ sensing-unit length, another a plurality of sensing units can be chosen for making the image-frame shift less than ½ sensing-unit length. For example, if the image frame 70, depicted in FIG. 5(c), has a right image-frame shift with ⅔ sensing-unit length, the sensing units 60g, 60h, 60m, and 60n are proper to be chosen for detecting the image presented on a single presenting unit, therefore, the image frame 70 is converted to having a left image-frame shift with ⅓ sensing-unit length.

As depicted in the FIG. 6, the error-data rate is increasing with the value of the image-frame shift (the dotted line) in conventional holographic storage system without the gain-controlling unit; however, the error-data rate is fixed within a range by the gain-controlling unit of the present invention.

Moreover, the misalignment between the image frame presented on the detecting apparatus and the image frame presented on the data plane is not always horizontal or vertical, the misalignment may result from the image frame is rotated. Under a 2× over-sampling technology, if the image frame is rotated, more than four sensing signals can be chosen for amplified, and these amplified sensing signals are summed as a summing signal for identifying.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A holographic storage system including:
a first light beam;
a second light beam;
a data plane including n presenting units for presenting an image frame, wherein the second light beam is converted to a signal beam containing the image frame after the second light beam is emitted to the data plane, and each presenting unit is capable of outputting a light state or a dark state;
a storage medium, wherein the first light beam and the signal beam are both focused on a focal point in the storage medium when the storage medium is use for data recording, and a data beam is generated if only the first light beam is focused on the focal point in the storage medium when the storage medium is use for data reading;
a detecting apparatus including m sensing units for receiving the image frames contained in the data beam and each sensing unit is capable of generating a corresponding sensing signal, wherein the m/n is an integer or a rational;
m gain-controlling units, connected to the m sensing units, for providing different gains to respectively amplify the corresponding sensing signals outputted from the sensing units; and
n SUMs, wherein each SUM is capable of outputting a summing signal which is a sum of partial amplified sensing signals within the m amplified sensing signals.

2. The holographic storage system according to claim 1, wherein the m/n is 4.

3. The holographic storage system according to claim 1, wherein the first light beam and the second light beam are from a laser beam split by a beam splitter.

4. The holographic storage system according to claim 1, wherein the data plane is a spatial light modulator.

5. The holographic storage system according to claim 4, wherein the spatial light modulator is a digital micro-mirror device or a liquid crystal display.

6. The holographic storage system according to claim 1, wherein the storage medium is a Photopolymer.

7. The holographic storage system according to claim 1, wherein the detecting apparatus is a charge-coupled device or a complementary metal oxide semiconductor.

8. The holographic storage system according to claim 1, wherein the n summing signals are use for identifying the images presented on the n corresponding presenting units.
